(19) United States
(12) Patent Application Publication
(10) Pub. No.: US 2008/0161996 A1
(43) Pub. Date: Jul. 3, 2008

(54) Method for dealing with traffic accident and apparatus thereof

(75) Inventors: Steve Chang, Taipei Hsien (TW); Qi Liu, Shanghai City (CN); James Xu, Shanghai City (CN); Jean Wang, Shanghai City (CN); Kane Shao, Shanghai City (CN)

Correspondence Address: Joe McKinney Muncy, PO Box 1364, Fairfax, VA, 22038-1364, US

(73) Assignee: Inventec Appliances Corp.

(21) Appl. No.: 12/003,563

(22) Filed: Dec. 28, 2007

(30) Foreign Application Priority Data
Dec. 29, 2006 (TW) 95150018

(51) Int. Cl. G06F 17/40; G01C 21/26

(52) U.S. Cl. 701/35

(57) ABSTRACT

A method for dealing with a traffic accident includes the following steps: the driving data of a car is detected, and then the driving data of the car is recorded. When the traffic accident occurs, the driving data of the car recorded for a period of time until the traffic accident is transferred to a traffic managing center.

### RELATED APPLICATIONS

This application claims priority to Taiwan Application Serial Number 95150018, filed Dec. 29, 2006, which is herein incorporated by reference.

### BACKGROUND

1. Field of Invention

The present invention relates to a monitoring system.

2. Description of Related Art

In recent years, the number of cars has increased significantly as the standard of living and purchasing power increase. As a result, traffic accidents occur frequently in modernized society.

When a traffic accident occurs, the drivers have to preserve the scene of the traffic accident for further investigation by the police or forensic experts. The investigation result and the oral evidence provided by the drivers will determine who should take responsibility for the traffic accident. However, such a way of dealing with the traffic accident often results in serious traffic jams, especially in the down town area. Therefore, the traditional way of dealing with the traffic accident not only wastes a lot of social cost but is also an inconvenience to other drivers.

### SUMMARY

According to one embodiment of the present invention, a method for dealing with a traffic accident includes the following steps: the driving data of a car is detected, and then the driving data of the car is recorded. When the traffic accident occurs, the driving data of the car recorded for a period of time until the traffic accident is transferred to a traffic managing center.

According to another embodiment of the present invention, an apparatus for dealing with a traffic accident includes a driving detector, a driving recorder, a determining module and a transferring module. The driving detector is used to detect the driving data of a car. The driving recorder is used to record the driving data of the car. The determining module is used to determine whether the traffic accident occurs. The transferring module is used to transfer the driving data of the car recorded for a period of time until the traffic accident to a traffic managing center when the traffic accident occurs.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a flow chart of a method for dealing with a traffic accident according to one embodiment of the present invention;

FIG. 2 is a flow chart of a method for dealing with a traffic accident according to another embodiment of the present invention;

FIG. 3 is a functional block diagram of an apparatus for dealing with a traffic accident according to one embodiment of the present invention;

FIG. 4 is a functional block diagram of the driving detector of FIG. 3; and

FIG. 5 is a functional block diagram of an apparatus for dealing with a traffic accident according to another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

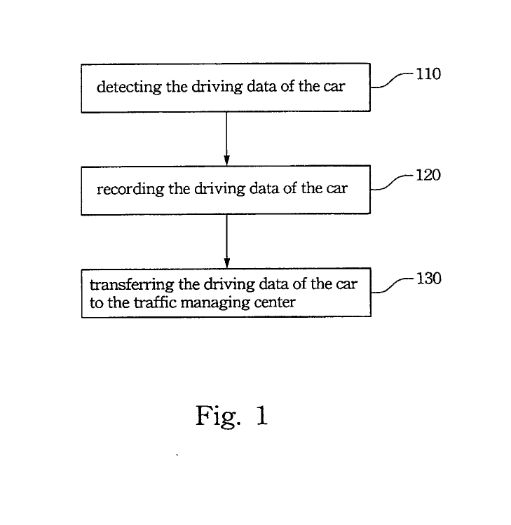

FIG. 1 is a flow chart of a method for dealing with a traffic accident according to one embodiment of the present invention. The method for dealing with the traffic accident includes the following steps: the driving data of a car is detected ceaselessly (step 110), and then the driving data of the car is recorded ceaselessly as well (step 120). When the traffic accident occurs, the driving data of the car recorded for a period of time until the traffic accident is transferred to a traffic managing center (step 130). That is, the driving data of the car can be a basis to determine who should take responsibility for the traffic accident, such that the investigation time can be reduced significantly.

More specifically, the driving data of the car may include the driving path of the car. The driving path of the car may be obtained by the following steps: the position of the car is detected by a global positioning system (GPS) and then recorded ceaselessly. The driving path of the car is calculated by at least distinct two of the positions of the car. Accordingly, the traffic managing center can simulate the traffic accident and determine who should take responsibility for the traffic accident by the driving path of the car.

Furthermore, the driving data of the car may also include the velocity of the car. The velocity of the car may be calculated according to the driving path of the car and a time interval therebetween. As a result, the traffic managing center will have more information about the traffic accident, such that the investigation result will be more correct.

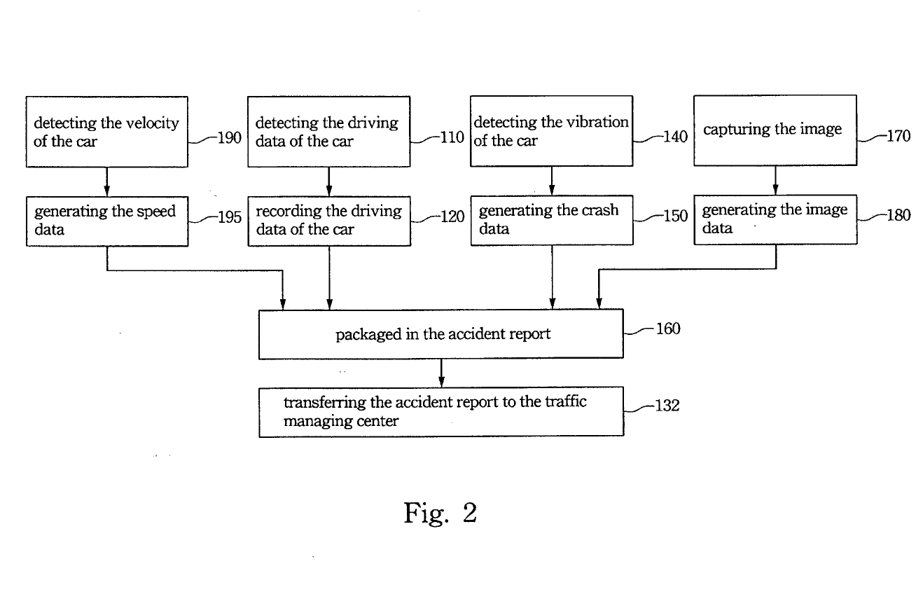

FIG. 2 is a flow chart of a method for dealing with a traffic accident according to another embodiment of the present invention. In addition to the driving data of the car, the method for dealing with the traffic accident of FIG. 2 further includes the step of detecting the vibration of the car (step 140). Whether the traffic accident occurs may be determined according to the vibration of the car. When the traffic accident occurs, a crash data is generated according the vibration of the car (step 150). Then, the crash data and the driving data of the car are packaged in an accident report (step 160). The accident report is transferred to the traffic managing center (step 132). The traffic managing center can find out how the car crashes and what part of the car is hit according to the accident report.

Moreover, the method for dealing with the traffic accident of FIG. 2 may also include the step of capturing at least one image from the car (step 170). An image data can be generated according to the image (step 180). The image data generated during the period of time is packaged in the accident report when the traffic accident occurs (step 160). Then, the accident report is transferred to the traffic managing center (step 132). Accordingly, the traffic managing center can find out how the traffic accident occurs more correctly according to the image data.

The velocity of the car may also be detected by a speedometer besides being obtained by the calculation. That is, the method for dealing with the traffic accident of FIG. 2 may include the step of detecting the velocity of the car by a speedometer (step 190). A speed data can be generated according to the velocity of the car (step 195). The speed data generated during the period of time is packaged in the accident report when the traffic accident occurs (step 160). Then, the accident report is transferred to the traffic managing center (step 132). Therefore, the traffic managing center can obtain the velocity of the car during the traffic accident according to the accident report.

Although the accident report of the present embodiment may include the driving data of the car, the crash data, the image data and the speed data, the content of the accident report is not limited to the above-mentioned information. The accident report may also include other information or just include a part of the above-mentioned information. Basically, the content of the accident report should depend on actual requirements. Furthermore, the accident report may also be saved in a file besides being transferred to the traffic managing center.

In the present embodiment, the period of time until the traffic accident is between 10-30 seconds. It is easily understood that the above-mentioned time period is only one example. The period of time may also be shorter than 10 seconds or longer than 30 seconds as long as the traffic managing center can obtain enough information to understand the situation of the traffic accident.

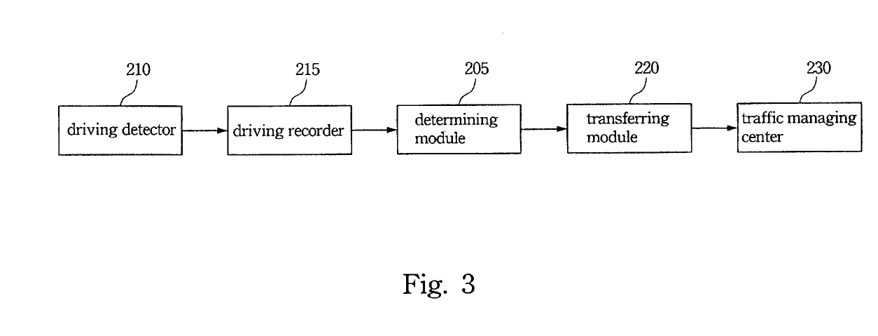

FIG. 3 is a functional block diagram of an apparatus for dealing with a traffic accident according to one embodiment of the present invention. The apparatus for dealing with the traffic accident includes a driving detector 210, a driving recorder 215, a determining module 205 and a transferring module 220. The driving detector 210 is used to detect the driving data of a car. The driving recorder 215 is used to record the driving data of the car. The determining module 205 is used to determine whether the traffic accident occurs. The transferring module 220 is used to transfer the driving data of the car recorded for a period of time until the traffic accident to a traffic managing center 230 when the traffic accident occurs. That is, the driving data of the car can be a basis to determine who should take responsibility for the traffic accident, such that the investigation time can be reduced significantly.

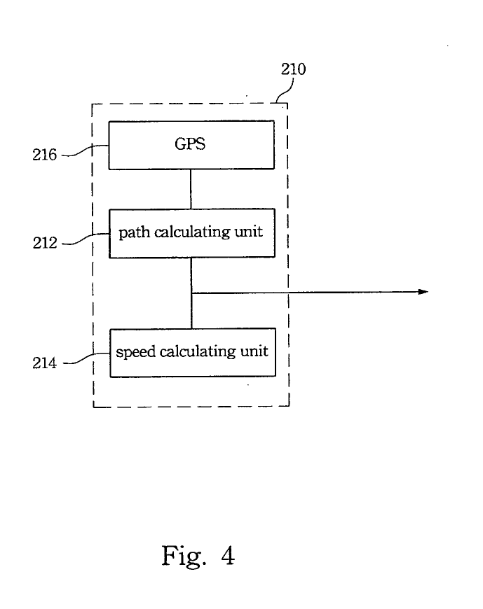

FIG. 4 is a functional block diagram of the driving detector 210 of FIG. 3. The driving detector 210 of FIG. 4 may include a global positioning system (GPS) 216 and a path calculating unit 212. The GPS 216 is used to detect and record the position of the car. The path calculating unit 212 is used to calculate the driving path of the car by at least distinct two of the positions of the car. Accordingly, the traffic managing center can simulate the traffic accident and determine who should take responsibility for the traffic accident by the driving path of the car.

Furthermore, the driving detector 210 of FIG. 4 may also include a speed calculating unit 214. The speed calculating unit 214 is used to calculating the velocity of the car according to the driving path of the car and a time interval therebetween. As a result, the traffic managing center will have more information about the traffic accident, such that the investigation result will be more correct.

The above mentioned determining module 205, the transferring module 220, the path calculating unit 212 and the speed calculating unit 214 can be either software or hardware. They do not need to be completely software or completely hardware. These modules and units can be a combination of both software and hardware.

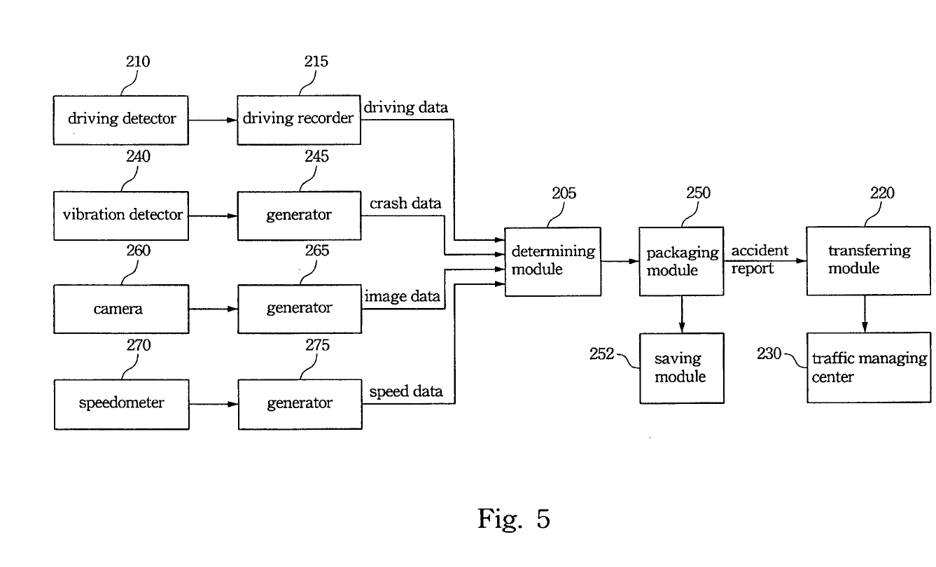

FIG. 5 is a functional block diagram of an apparatus for dealing with a traffic accident according to another embodiment of the present invention. In addition to the driving data of the car provided by the driving detector 210, the apparatus for dealing with the traffic accident of FIG. 5 further includes a vibration detector 240, a generator 245 and a packaging module 250. The vibration detector 240 is used to detect the vibration of the car. The generator 245 is used to generate a crash data according the vibration of the car. The packaging module 250 is used to package the crash data and the driving data of the car in an accident report when the traffic accident occurs. Then, the transferring module 220 may transfer the accident report to the traffic managing center 230. The traffic managing center 230 can find out how the car crashes and what part of the car is hit according to the accident report.

The above mentioned vibration detector 240 can be a vibration sensor or an accelerometer. However, the vibration detector is not limited to the vibration sensor or the accelerometer. The vibration detector may also be other devices.

In addition, the apparatus for dealing with the traffic accident of FIG. 5 may also include a camera 260 and another generator 265. The camera 260 may be mounted on the car or other proper positions to capture at least one image from the car. The generator 265 is used to generate an image data according to the image. The image data generated during the period of time may be packaged in the accident report by the packaging module 250 when the traffic accident occurs. Then, the accident report is transferred to the traffic managing center 230 by the transferring module 220. Accordingly, the traffic managing center 230 can find out how the traffic accident occurs more correctly according to the image data.

The velocity of the car may also be detected by a speedometer besides being obtained by the calculation. That is, the apparatus for dealing with the traffic accident of FIG. 5 may include a speedometer 270 and yet another generator 275. The speedometer 270 is used to detect the velocity of the car. The generator 275 is used to generate a speed data according to the velocity of the car. The speed data generated during the period of time may be packaged in the accident report by the packaging module 250 when the traffic accident occurs. Then, the accident report is transferred to the traffic managing center 230 by the transferring module 220. Therefore, the traffic managing center 230 can obtain the velocity of the car during the traffic accident according to the accident report.

The determining module 205 may determine whether the traffic accident occurs by the driving path, the vibration or the velocity of the car. Furthermore, the determining module 205 may also give weights to them according to actual requirements and then determine whether the traffic accident occurs by a combination thereof.

The above mentioned determining module 205, the packaging module 250 and the transferring module 220 can be either software or hardware. They do not need to be completely software or completely hardware. These modules can be a combination of both software and hardware. For example, the packaging module 250 shown in FIG. 5 may be built in an automotive GPS. Furthermore, the automotive GPS may also serve as the transferring module 220 to transfer the accident report by a mobile data service, e.g. General Packet Radio Service (GPRS), EDGR, 3G or 3.5G, or other wireless technology, e.g. WiFi or WiMAX.

For some general traffic accidents, the traffic managing center 230 may make the judgement directly according to the accident report after receiving the accident report. Then, the judgement will be sent to the drivers by a wireless communication service for the following conciliation and processing, and no arrival is needed. Accordingly, the scene of the traffic accident does not have to be preserved for further investigation, and thus the traffic jam problem will be solved. Furthermore, the accident report and the judgement can also be saved by a saving module 252 in a file for future reference.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for dealing with a traffic accident, comprising steps of:
detecting the driving data of a car;
recording the driving data of the car; and
transferring the driving data of the car recorded for a period of time until the traffic accident to a traffic managing center when the traffic accident occurs.

2. The method for dealing with the traffic accident according to claim 1, wherein the step of recording the driving data of the car comprises:
detecting the position of the car by a global positioning system;
recording the position of the car; and
calculating the driving path of the car by at least distinct two of the positions of the car.

3. The method for dealing with the traffic accident according to claim 2, wherein the step of recording the driving data of the car comprises:
calculating the velocity of the car according to the driving path of the car and a time interval therebetween.

4. The method for dealing with the traffic accident according to claim 1, further comprising:
detecting the vibration of the car;
determining whether the traffic accident occurs according to the vibration of the car; and
generating a crash data according the vibration of the car when the traffic accident occurs.

5. The method for dealing with the traffic accident according to claim 4, further comprising:
packaging the crash data and the driving data of the car in an accident report.

6. The method for dealing with the traffic accident according to claim 5, further comprising:
transferring the accident report to the traffic managing center; and
saving the accident report in a file.

7. The method for dealing with the traffic accident according to claim 1, further comprising:
capturing at least one image from the car; and
generating an image data according to the image.

8. The method for dealing with the traffic accident according to claim 7, further comprising:
packaging the image data and the driving data of the car in an accident report.

9. The method for dealing with the traffic accident according to claim 8, further comprising:
transferring the accident report to the traffic managing center; and
saving the accident report in a file.

10. The method for dealing with the traffic accident according to claim 1, further comprising:
detecting the velocity of the car by a speedometer; and
generating a speed data according to the velocity of the car.

11. The method for dealing with the traffic accident according to claim 10, further comprising:
packaging the speed data generated during the period of time and the driving data of the car in an accident report.

12. The method for dealing with the traffic accident according to claim 11, further comprising:
transferring the accident report to the traffic managing center; and
saving the accident report in a file.

13. An apparatus for dealing with a traffic accident, comprising:
a driving detector for detecting the driving data of a car;
a driving recorder for recording the driving data of the car;
a determining module for determining whether the traffic accident occurs; and
a transferring module for transferring the driving data of the car recorded for a period of time until the traffic accident to a traffic managing center when the traffic accident occurs.

14. The apparatus for dealing with the traffic accident according to claim 13, wherein the driving detector comprises:
a global positioning system for detecting the position of the car; and
a path calculating unit for calculating the driving path of the car by at least distinct two of the positions of the car.

15. The apparatus for dealing with the traffic accident according to claim 14, wherein the determining module determines whether the traffic accident occurs by the driving path of the car.

16. The apparatus for dealing with the traffic accident according to claim 14, wherein the driving detector comprises:
a speed calculating unit for calculating the velocity of the car according to the driving path of the car and a time interval therebetween.

17. The apparatus for dealing with the traffic accident according to claim 16, wherein the determining module determines whether the traffic accident occurs by the velocity of the car.

18. The apparatus for dealing with the traffic accident according to claim 13, further comprising:
a vibration detector for detecting the vibration of the car; and
a generator for generating a crash data according the vibration of the car.

19. The apparatus for dealing with the traffic accident according to claim 18, wherein the determining module determines whether the traffic accident occurs by the vibration of the car.

20. The apparatus for dealing with the traffic accident according to claim 18, further comprising:
a packaging module for packaging the crash data and the driving data of the car in an accident report.

21. The apparatus for dealing with the traffic accident according to claim 20, further comprising:
a saving module for saving the accident report in a file.

22. The apparatus for dealing with the traffic accident according to claim 13, further comprising:
a camera for capturing at least one image from the car; and
a generator for generating an image data according to the image.

23. The apparatus for dealing with the traffic accident according to claim 22, further comprising:
a packaging module for packaging the image data generated during the period of time and the driving data of the car in an accident report.

24. The apparatus for dealing with the traffic accident according to claim 23, further comprising:
a saving module for saving the accident report in a file.

25. The apparatus for dealing with the traffic accident according to claim 13, further comprising:
a speedometer for detecting the velocity of the car; and
a generator for generating a speed data according to the velocity of the car.

26. The apparatus for dealing with the traffic accident according to claim 25, wherein the determining module determines whether the traffic accident occurs by the velocity of the car.

27. The apparatus for dealing with the traffic accident according to claim 25, further comprising:
a packaging module for packaging the speed data generated during the period of time and the driving data of the car in an accident report.

28. The apparatus for dealing with the traffic accident according to claim 27, further comprising:
a saving module for saving the accident report in a file.
